(19) United States
(12) Patent Application Publication
(10) Pub. No.: US 2020/0007051 A1
(43) Pub. Date: Jan. 2, 2020

(54) Commutating Circuit Device and Method for Reducing the Load on at Least One Semiconductor of a Converter and Vehicle Comprising a Commutating Circuit Device

(71) Applicant: ZF FRIEDRICHSHAFEN AG, Friedrichshafen (DE)

(72) Inventor: Alexander BIRK, Mittelbiberach (DE)

(73) Assignee: ZF FRIEDRICHSHAFEN AG, Friedrichshafen (DE)

(21) Appl. No.: 16/465,425

(22) PCT Filed: Nov. 16, 2017
(86) PCT No.: PCT/EP2017/079470

§ 371 Date: May 30, 2019

(30) Foreign Application Priority Data
Dec. 9, 2016 (DE) 10 2016 224 422.1

(51) Int. Cl. H02M 7/537; H02P 6/14; H02M 1/34

(52) U.S. Cl. CPC H02M 7/537; H02M 2001/0054; H02M 1/34; H02P 6/14

(57) ABSTRACT

The present approach relates to a commutating circuit device (100) for reducing the load on at least one semiconductor of a converter (103). The commutating circuit device (100) comprises at least one first contact (105) and one second contact (110) for connecting to a battery (155), and also an intermediate circuit capacitor (115), which has a first capacitance and a first parasitic inductance (160), and the output-side converter (103). A second switch mechanism (130) and a third switch mechanism (135) of the converter (103) can be controlled by control signals. The commutating circuit device (100) also comprises the second serial connection (140) composed of a first switch mechanism (145) and a snubber (150) that has a first capacitance and a second parasitic inductance (165), wherein the second capacitance is lower than the first capacitance, and/or the second parasitic inductance (165) is lower than the first parasitic conductance (160).

The present approach relates to a commutating circuit device and a method for reducing the load on at least one semiconductor of a converter and a vehicle comprising a commutating circuit device.

In the development of a power converter, the intention is to reduce the leakage inductance in the commutation path, in order to limit switch-off losses to a minimum. Very low parasitic inductances have a positive effect on the switch-off behavior, but a negative effect on the switch-on behavior.

Based on this, the present approach produces an improved commutating circuit device for reducing the load on at least one semiconductor of a converter, a vehicle with an improved commutating circuit device, and an improved method for reducing the load on at least one semiconductor of a converter according to the independent claims. Advantageous embodiments can be derived from the independent claims and the following description.

A commutating circuit device for reducing the load on at least one semiconductor of a converter comprises at least one first contact and one second contact for connecting to a battery, and an intermediate circuit capacitor interconnected between the first contact and the second contact, which comprises a first capacitance and a first parasitic inductance, and the output-side converter, which is connected to the intermediate circuit capacitor, and the first contact and the second contact, via a first connecting line and a second connecting line, which comprises at least a first serial connection composed of a second switch mechanism and a third switch mechanism, in order to convert a DC voltage at the first contact and the second contact to an AC voltage at an output contact located between the second switch mechanism and the third switch mechanism. The second switch mechanism and the third switch mechanism can be controlled using control signals. The commutating circuit device also comprises a second serial connection, located in parallel to the intermediate circuit capacitor and the converter, composed of a first switch mechanism that can be controlled with another control signal, and a snubber that has a second capacitance and a second parasitic inductance, wherein the second capacitance is lower than the first capacitance of the intermediate circuit capacitor, and/or the second parasitic inductance is lower than the first parasitic inductance of the intermediate circuit capacitor.

According to one embodiment, a first connection of the second switch mechanism is connected to a first connection of the second serial connection, and a first connection of the intermediate circuit capacitor. A second connection of the second switch mechanism is connected to the output contact and a first connection of the third switch mechanism, and a second connection of the third switch mechanism is connected to a second connection of the second serial connection and a second connection of the intermediate circuit capacitor.

A switch mechanism, also referred to as a valve, can be implemented in the form of a transistor. A commutating circuit device described herein can advantageously enable two different commutating paths with parasitic inductances of different levels. When switched on, it is advantageous when there is a high parasitic inductance, because when commutating the current from the diode to the semiconductor, if the second and third switch mechanisms each comprise a diode and a semiconductor, a high current change is caused by the quick switching procedures. The high parasitic inductance is beneficial for the voltage drop in the semiconductor, thus resulting in lower power losses in the switching procedure. In the switching-off procedure, in contrast, it is advantageous when there is a low parasitic inductance, because this results in a significant reduction in excess voltage caused during the commutation procedure by the current change. When the parasitic inductance is reduced, the switching rate can be increased with the same excess voltage, such that the resulting switching losses are minimized.

With the commutating circuit device the first commutation path with the higher parasitic inductance than then be used advantageously for the switching-on procedure, and the second commutation path with the lower parasitic inductance can be used for the switching-off procedure.

Advantageously, the second switch mechanism and the third switch mechanism can be controlled by the control signal, and the first switch mechanism can be controlled by the other control signal, such that a first commutation path that passes through the intermediate circuit capacitor and the converter is activated during the switching-on procedure, and a second commutation path that passes through the second serial connection and the converter is activated during the switching-off procedure. A switching-on procedure can be understood to be an activation of the second switch mechanism and/or the third switch mechanism. A switching-off procedure can be understood to be a deactivation of the second switch mechanism and the third switch mechanism. In order to be able to activate the corresponding commutation path, the control signals can be coordinated to one another, e.g. with regard to their switching ramps.

According to an advantageous embodiment of the commutating circuit device, the snubber can be in the form of a snubber capacitor, or at least comprise a snubber capacitor. The snubber can thus be a known circuit for neutralizing disruptive voltage peaks.

The other control signal can have switching ramps according to one embodiment, which are temporally offset to the switching ramps of the control signals of the second switch mechanism and the third switch mechanism. By way of example, a mechanism can be used for this that is configured to generate the other control signal with switching ramps that are temporally offset to the switching ramps of the control signals. The first switch mechanism can thus be switched off prior to the second and third switch mechanisms, such that the first commutation path is activated during the switching-on procedure. As soon as the switching-on procedure is completed, the first switch mechanism can be switched on, in order to activate the second commutation path for the subsequent switching-off procedure.

By way of example, the other control signal can be generated via an “or” conjunction comprised of the control signals of the second and third switch mechanisms. For this, a logical device can be used that is configured to generate the other control signal from the control signals using an “or” conjunction. Such a conjunction can be implemented very easily.

Advantageously, the commutating circuit device can also have a delay mechanism, which is configured to delay an intermediate signal provided by the logical device, and output it as the other control signal. The delay mechanism enables an offset to be obtained between the switching ramps of the other control signal for the other switch mechanism and the control signals for the second switch mechanism and the third switch mechanism.

The first connecting line between the first contact and the first connection of the second switch mechanism of the converter can be a through circuit according to one embodiment, i.e. the first connecting line has no inductor, no capacitor, and no resistor according to this embodiment. As a result, electric energy can flow with very low losses through the first connecting line to the converter.

A vehicle has one of the commutating circuit devices presented herein. The commutating circuit device presented herein can replace known commutating circuit devices. The commutating circuit device can be used to control an electric motor in the vehicle.

A method for reducing the load on at least one semiconductor of a converter using a commutating circuit device according to the approach presented herein comprises the following steps:

Sending the control signals to the second switch mechanism and the third switch mechanism, and the other control signal to the first switch mechanism during a switching-on procedure, in order to switch off the second switch mechanism or the third switch mechanism, and also switch off the first switch mechanism, such that a first commutation path passing through the intermediate circuit capacitor and the converter is activated; and

Sending the control signals to the second switch mechanism and the third switch mechanism, and the other control signal to the first switch mechanism during a switching-off procedure, in order to switch off the second switch mechanism and the third switch mechanism, and also switch on the first switch mechanism, such that a second commutation path passing through the second serial connection and the converter is activated.

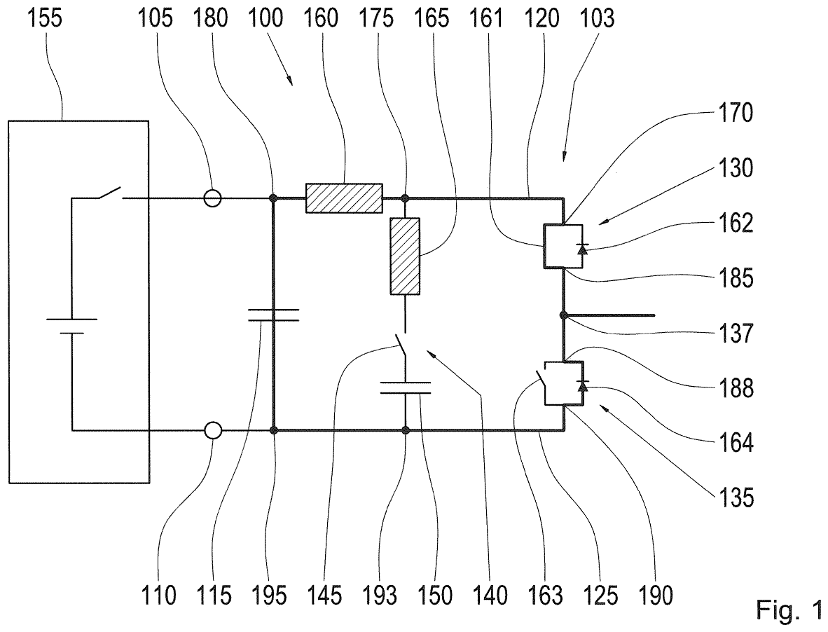

FIG. 1 shows a commutating circuit device according to an exemplary embodiment;

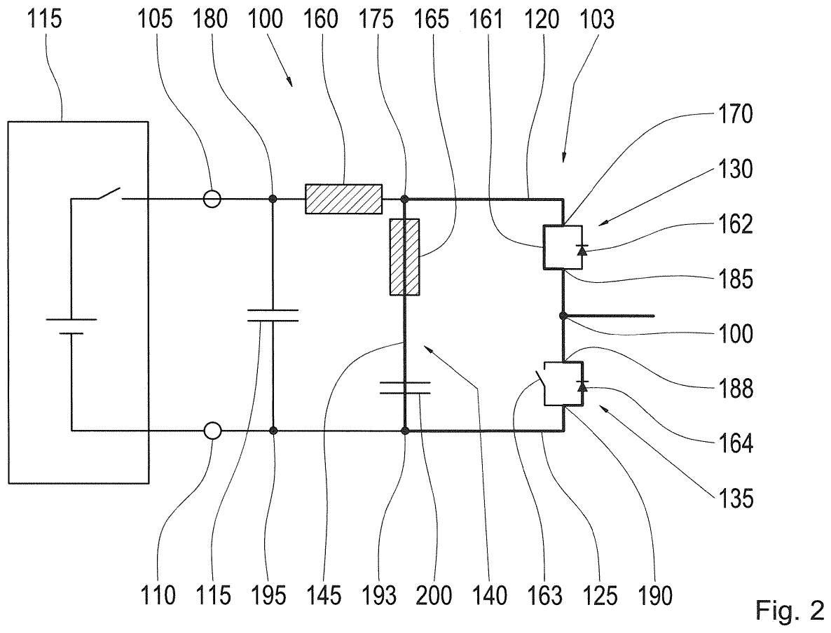

FIG. 2 shows a commutating circuit device according to an exemplary embodiment;

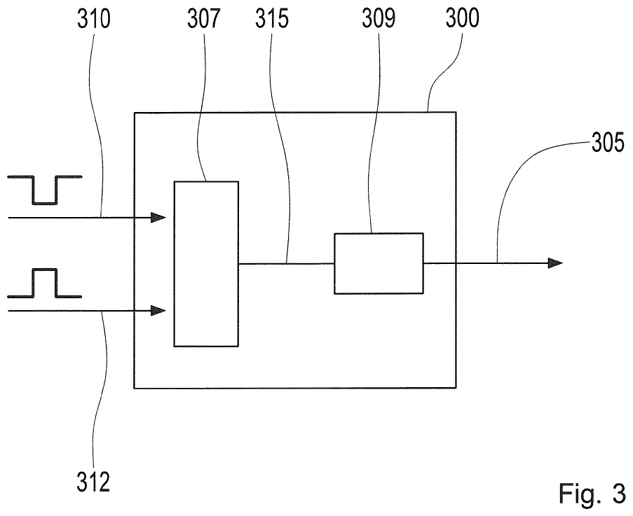

FIG. 3 shows a device for generating another control signal according to an exemplary embodiment;

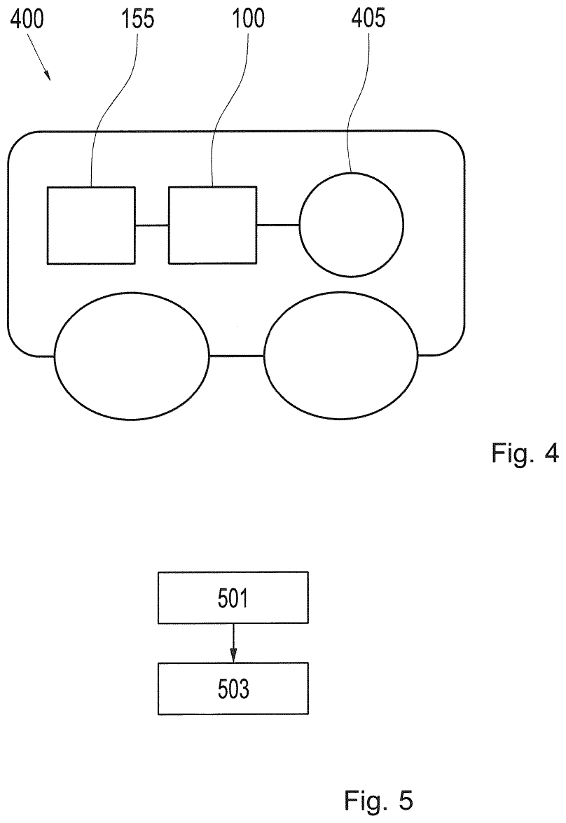

FIG. 4 shows a vehicle with a commutating circuit device according to an exemplary embodiment; and

FIG. 5 shows a flow chart for a method for reducing the load on at least one semiconductor of a converter according to an exemplary embodiment.

In the following description of preferred embodiments of the present approach, the same or similar reference symbols are used for the elements shown in the various figures that have similar functions, wherein the descriptions of these elements shall not be repeated.

FIG. 1 shows a commutating circuit device 100 according to an exemplary embodiment. The commutating circuit device 100 is configured to reduce the load on at least one semiconductor of a converter 103. The commutating circuit device 100 comprises at least one first contact 105, one second contact 110, one intermediate circuit capacitor 115, one first connecting line 120, one second connecting line 125, the converter 103, which comprises a first serial connection composed of a second switch mechanism 130 and a third switch mechanism 135, an output contact 137, and a second serial connection 140 composed of a first switch mechanism 145 and a snubber 150.

The output contact 137 can be connected, by way of example, to a phase of an electric motor that can be controlled using the commutating circuit device 100.

A battery 155, e.g. a traction battery for a vehicle, is connected to the first contact 105 and the second contact 110 according to this exemplary embodiment. The intermediate circuit capacitor 115 is interconnected between the first contact 105 and the second contact 110, and has a first capacitance and a schematically illustrated first parasitic inductance 160. The converter 103 is connected to the intermediate circuit capacitor 115 and the first contact 105 via the first connecting line 120, and to the intermediate circuit capacitor 115 and the second contact 110 via the second connecting line 125. The output contact 137 is located between the second switch mechanism 130 and the third switch mechanism 135 of the converter 103. The converter 103 is configured to convert a DC voltage at the first contact 105 and the second contact 110 to an AC voltage at the output contact 137. The second switch mechanism 130 and the third switch mechanism 135 can be controlled for this by control signals, such that the output contact 137 is connected in a temporally offset manner to the first contact 105 and the second contact 110.

The second switch mechanism 130 has a second switch 161 and a second diode 162 according to this exemplary embodiment, and the third switch mechanism 135 has a third switch 163 and a third diode 164. By way of example, the switch mechanisms 130, 135 can each be in the form of transistors.

The second serial connection 140 is parallel to the intermediate circuit capacitor 115 and the converter 103, and the second serial connection 140 is located between the intermediate circuit capacitor 115 and the converter 103 according to this exemplary embodiment. The first switch mechanism 145 of the second serial connection 140 can be controlled by another control signal. The snubber 150 has a second capacitance and a schematically illustrated second parasitic inductance 165, wherein the second capacitance is lower than the first capacitance of the intermediate circuit capacitor 115, and the second parasitic inductance 165 is lower than the first parasitic inductance 160 of the intermediate circuit capacitor 115. According to the exemplary embodiment shown herein, the snubber 150 is located at the second contact 110. Alternatively, the snubber 150 can be located at the first contact 105.

The switch mechanisms 130, 135, 145 can be controlled by control signals such that during a switching-on procedure, a first commutation path passes through the intermediate circuit capacitor 115 and the converter 103, and during a switching-off procedure, a second commutation path passes through the second serial connection 140 and the converter 103.

According to this exemplary embodiment, the first connection 170 of the second switch mechanism 130 is connected to a first connection 175 of the second serial connection 140, and a first connection 180 of the intermediate circuit capacitor 114. A second connection 185 of the second switch mechanism 130 is connected to the output contact 137 and a first connection 188 of the third switch mechanism 135 and a second connection 190 of the third switch mechanism 135 are connected to a second connection 193 of the second serial connection 140 and a second connection 195 of the intermediate circuit capacitor 115. The first connecting line 120 forms a through circuit between the first contact 105 and the first connection 170 according to this exemplary embodiment.

The details of the commutating circuit device 100 shall be explained in greater detail below. A reduction in leakage inductance is associated with an increase in the structural complexity, and usually with higher costs. The level of the leakage inductance in a commutation path has a large effect on the switching behavior, the electromagnetic compatibility, losses and ultimately on a yield of the semiconductor. When the leakage inductance is reduced, excess voltages at a bipolar transistor with an insulated-gate electrode, abbreviated as IGBT [insulated-gate bipolar transistor], caused by parasitic inductances when switching off, are significantly reduced. If an ideal current source is used to operate the semiconductor, this excess voltage would be the limiting value when switching off the semiconductor. This means that a switching rate of the switching-off procedure is accelerated by a reduction in the leakage inductance. A short switch-off time therefore reduces the switching losses of the semiconductor. A reduction in the parasitic inductances in the second commutation path by the second parasitic inductance 165 accordingly reduces the switch-off losses with the same excess voltage during the switching-off procedure according to this exemplary embodiment. The switch-on losses increase, however, when the leakage inductance is reduced, because the parasitic inductance causes a voltage drop during the commutation procedure, such that the current from a diode to a semiconductor of an opposing valve, e.g. from the third diode 164 to the second switch 161 in the form of a semiconductor, decreases due to an increased portion of the terminal voltage through the semiconductor.

The commutating circuit device 100 presented herein forms a good compromise between the distribution of the switching-off and switching-on losses, and can ultimately apply the correct leakage inductance in the commutation paths through parasitic inductances 160, 165 of different levels, which can differ greatly in different semiconductor switch generations. The point is that very low leakage inductances have a positive effect on the switching-off behavior, but a negative effect on the switching-on behavior.

For the switching on and off of the semiconductors 161, 163, two different commutation paths, which can also be referred to as commutation loops, are used advantageously in the commutation circuit device 100 presented herein.

In FIG. 1, the first commutation path in the switching-on procedure is indicated by a thick line. In the state shown in FIG. 1, the first switch mechanism 145 and the third switch mechanism 135 are switched off, and the second switch mechanism 130 is switched on. In this manner, the first contact 105 is connected to the output contact 137 via the second switch mechanism 130.

The intermediate circuit capacitor 115 represents an intermediate circuit capacitance, previously referred to as the first capacitance, which has the first parasitic inductance 160, wherein the snubber 150, which is incorporated in the second commutation path, represents a snubber capacitance, previously referred to as the second capacitance, which has the second parasitic inductance 165. The first capacitance is greater than the second capacitance, and the first parasitic inductance 160 is greater than the second parasitic inductance 165. The first commutation path is used in the switching on, in order to significantly reduce the losses in the semiconductor. When the current is commutated from a diode to a semiconductor, a high level of current change is caused by quick switching procedures. The parasitic inductance 160 is beneficial for the voltage drop of the semiconductor, thus resulting in lower performance losses in the switching procedure. For this procedure, a switch in the first switch mechanism 145 remains switched off, such that the parasitic inductance 160 causes a large voltage drop.

FIG. 2 shows a commutating circuit device 100 according to an exemplary embodiment. This can be the commutating circuit device 100 described in reference to FIG. 1.

In the state shown in FIG. 2, the first switch mechanism 145 is switched on, and the second switch mechanism 130 and the third switch mechanism 135 are switched off.

According to this exemplary embodiment, the second commutation path is activated, instead of the first commutation path, as indicated in FIG. 2 by a thick line. The second commutation path ends at the snubber, which in this exemplary embodiment is in the form of a snubber capacitor 200. According to this exemplary embodiment, the elements of the second serial connection 140 are integrated directly in a power electronics module of the converter 103.

During the switching-off procedure, the first switch, also referred to as the first switch mechanism 145, is switched on, as shown, and the second commutation path is used. The excess voltage caused by the current change during the commutation procedure is significantly reduced by the second commutation path with the significantly lower second parasitic inductance 165. A maximum excess voltage during the switching-off procedure is delimited by the breakdown voltage of the semiconductor. With the reduced second parasitic inductance 165, the switching rate can be increased with the same excess voltage, thus minimizing the resulting switching losses.

FIG. 3 shows a device 300 for generating another control signal 305 according to an exemplary embodiment. This can be a device 300 that is configured to generate the other control signal 305 for controlling the first switch mechanism described in reference to FIG. 1.

The device 300 has a logical device 307 and a delay mechanism 309 for this. The logical device 307 is configured to receive a second control signal 310 for controlling the second switch mechanism described in reference to FIGS. 1 and 2, and a third control signal 312 for controlling the third switch mechanism described in reference to FIGS. 1 and 2, and to generate an intermediate signal 315 on the basis of the control signals 310, 312. According to this exemplary embodiment, the logical device 307 is configured to generate the intermediate signal 315 via an “or” conjunction of the control signals 310, 312. The delay mechanism 309 is configured to receive the intermediate signal 315, delay it, and output it as the other control signal 305.

According to this exemplary embodiment, the other control signal 305 has switching ramps that are temporally offset to the switching ramps of the control signal 310.

In other words, a logical system for controlling the first switch of the switch mechanism by the other control signal 305 is described in reference to FIG. 3. The use of the first commutation path or the second commutation path is very easily implemented in terms of hardware. The first switch of the first switch mechanism is switched on by the other control signal 305 at a temporal offset to the control signals 310 of the second switch mechanism and the third switch mechanism, which is used during the switching-on procedure for the first commutation path. The second switch mechanism and the third switch mechanism can also be referred to as load valves. As soon as the switching-on procedure is completed, the first switch is switched on, and the second commutation path is used for the next commutation procedure, thus the switching-off procedure.

According to the exemplary embodiment shown therein, the mechanism 300 is configured to generate the other control signal 305 using the control signals 310, 312. According to an alternative exemplary embodiment, an alternative mechanism 300 is configured to generate the control signals 310, 312 using the other control signal 305 or to collectively generate the control signals 305, 310, 312 according to an appropriate generating guideline.

FIG. 4 shows a vehicle 400 with a commutating circuit device 100 according to an exemplary embodiment. This commutating circuit device 100 can be the commutating circuit device 100 described in reference to FIG. 1 or 2.

The commutating circuit device 100 is used according to this exemplary embodiment for converting a DC voltage from a battery 155 in the vehicle 400 into an AC voltage for operating an electric motor 405 for powering the vehicle 400.

According to one exemplary embodiment, the electric motor 405 is a three-phase electric motor, and the commutating circuit device 100 has three current converters accordingly, the output contacts of which are each connected to a phase of the three-phase electric motor.

FIG. 5 shows a flow chart for a method for reducing the load on at least one semiconductor of a converter using a commutating circuit device according to an exemplary embodiment. This can be a commutating circuit device such as described in reference to either of the FIG. 1 or 2.

In step 501, control signals are sent to the switch mechanisms of the commutating circuit device, through which one of the switch mechanisms of the converter, as well as the first switch mechanism that is connected in parallel to the converter, are switched off during a switching-on procedure. In doing so, the control signal for switching off the first switch mechanism is sent shortly before the control signal for switching off the switch mechanism of the converter, according to one exemplary embodiment.

In step 503, control signals are sent to the switch mechanisms of the commutating circuit device, through which the switch mechanism of the converter is switched off, and the first switch mechanism, connected in parallel to the converter, is switched on during a switching-off procedure.

Steps 501, 503 can be repeated, wherein in successive steps 501, the second and third switch mechanisms of the converter can be switched off in an alternating manner. If an exemplary embodiment comprises an “and/or” conjunction between a first feature and a second feature, this can be read to mean that the exemplary embodiment according to one embodiment includes both the first feature and the second feature, and according to another embodiment, includes either just the first feature or just the second feature.

### REFERENCE SYMBOLS

100 commutating circuit device
103 converter
105 first contact
110 second contact
115 intermediate circuit capacitor
120 first connecting line
135 second connecting line
137 output contact
140 second serial connection
145 first switch mechanism
150 snubber
155 battery
160 first parasitic inductance
161 second switch
162 second diode
163 third switch
164 third diode
165 second parasitic inductance
170 first connection for the second switch mechanism
175 first connection for the second serial connection
180 first connection for the intermediate circuit capacitor
185 second connection for the second switch mechanism
188 first connection for the third switch mechanism
190 second connection for the third switch mechanism
193 second connection for the second serial connection
195 second connection for the intermediate circuit capacitor
310 second control signal
312 third control signal
307 logical device
309 delay mechanism
315 intermediate signal
400 vehicle
501 sending step
503 sending step

1. A commutating circuit device for reducing the load on at least one semiconductor of a converter, wherein the commutating circuit device comprises at least the following features:
a first contact and a second contact for connecting to a battery;
an intermediate circuit capacitor interconnected between the first contact and the second contact, which has a first capacitance and a first parasitic inductance;
the output-side converter connected to the intermediate circuit capacitor and the first contact and the second contact via a first connecting line and a second connecting line, which comprises at least a first serial connection composed of at least one second switch mechanism and one third switch mechanism, in order to convert a DC voltage at the first contact and the second contact to an AC voltage at an output contact located between the second switch mechanism and the third switch mechanism, wherein the second switch mechanism and the third switch mechanism can be controlled by control signals; and
a second serial connection composed of a first switch mechanism located in parallel to the intermediate circuit capacitor and the converter, which can be controlled by an control signal, and a snubber that has a second capacitance and a second parasitic inductance, wherein the second capacitance is lower than the first capacitance of the intermediate circuit capacitor, and/or the second parasitic inductance is lower than the first parasitic inductance of the intermediate circuit capacitor.

2. The commutating circuit device according to claim 1, in which the second switch mechanism and the third switch mechanism can be controlled by the control signals and the first switch mechanism can be controlled by the other control signal, in order to activate a first commutation path passing through the intermediate circuit capacitor and the converter during a switching-on procedure, and to activate a second commutation path passing through the second serial connection and the converter during a switching-off procedure.

3. The commutating circuit device according to claim 1, in which the snubber is a snubber capacitor.

4. The commutating circuit device according to claim 1, with a mechanism that is configured to generate the other control signal with switching ramps that are temporally offset to the switching ramps of the control signals.

5. The commutating circuit device according to claim 1, with a logical device that is configured to generate the other control signal from the control signals using an “or” conjunction.

6. The commutating circuit device according to claim 5, with a delay mechanism that is configured to delay an intermediate signal supplied by the logical device, and to output it as the other control signal.

7. The commutating circuit device according to claim 1, in which the first connecting line between the first contact and a connection on the converter is a through circuit.

8. A vehicle that has the commutating circuit device according to claim 1, wherein the output contact is connected to a connection on an electric motor of the vehicle.

9. A method for reducing the load on at least one semiconductor of a converter using the commutating circuit device according to claim 1, wherein the method comprises the following steps:
sending the control signals to the second switch mechanism and the third switch mechanism, and the other control signal to the first switch mechanism during a switching-on procedure, in order to switch off the second switch mechanism or the third switch mechanism, and also switch off the first switch mechanism, such that a first commutation path passing through the intermediate circuit capacitor and the converter is activated; and
sending the control signals to the second switch mechanism and the third switch mechanism, and the other control signal to the first switch mechanism during a switching-off procedure, in order to switch off the second switch mechanism and the third switch mechanism, and also switch on the first switch mechanism, such that a second commutation path passing through the second serial connection and the converter is activated.

10. The commutating circuit device according to claim 2, in which the snubber is a snubber capacitor.

11. The commutating circuit device according to claim 2, with a mechanism that is configured to generate the other control signal with switching ramps that are temporally offset to the switching ramps of the control signals.

12. The commutating circuit device according to claim 3, with a mechanism that is configured to generate the other control signal with switching ramps that are temporally offset to the switching ramps of the control signals.

13. The commutating circuit device according to claim 2, with a logical device that is configured to generate the other control signal from the control signals using an “or” conjunction.

14. The commutating circuit device according to claim 3, with a logical device that is configured to generate the other control signal from the control signals using an “or” conjunction.

15. The commutating circuit device according to claim 2, in which the first connecting line between the first contact and a connection on the converter is a through circuit.

16. The commutating circuit device according to claim 3, in which the first connecting line between the first contact and a connection on the converter is a through circuit.

17. A vehicle that has the commutating circuit device according to claim 2, wherein the output contact is connected to a connection on an electric motor of the vehicle.

18. A vehicle that has the commutating circuit device according to claim 3, wherein the output contact is connected to a connection on an electric motor of the vehicle.

19. A method for reducing the load on at least one semiconductor of a converter using the commutating circuit device according to claim 2, wherein the method comprises the following steps:
sending the control signals to the second switch mechanism and the third switch mechanism, and the other control signal to the first switch mechanism during a switching-on procedure, in order to switch off the second switch mechanism or the third switch mechanism, and also switch off the first switch mechanism, such that a first commutation path passing through the intermediate circuit capacitor and the converter is activated; and
sending the control signals to the second switch mechanism and the third switch mechanism, and the other control signal to the first switch mechanism during a switching-off procedure, in order to switch off the second switch mechanism and the third switch mechanism, and also switch on the first switch mechanism, such that a second commutation path passing through the second serial connection and the converter is activated.

20. A method for reducing the load on at least one semiconductor of a converter using the commutating circuit device according to claim 3, wherein the method comprises the following steps:
sending the control signals to the second switch mechanism and the third switch mechanism, and the other control signal to the first switch mechanism during a switching-on procedure, in order to switch off the second switch mechanism or the third switch mechanism, and also switch off the first switch mechanism, such that a first commutation path passing through the intermediate circuit capacitor and the converter is activated; and
sending the control signals to the second switch mechanism and the third switch mechanism, and the other control signal to the first switch mechanism during a switching-off procedure, in order to switch off the second switch mechanism and the third switch mechanism, and also switch on the first switch mechanism, such that a second commutation path passing through the second serial connection and the converter is activated.
